(19) United States
(12) Patent Application Publication
(10) Pub. No.: US 2016/0306360 A1
(43) Pub. Date: Oct. 20, 2016

(54) SYSTEM AND METHOD FOR AUTONOMOUS CONTROL OF LOCOMOTIVES

(71) Applicant: Electro-Motive Diesel, Inc., LaGrange, IL (US)

(72) Inventor: James David SEATON, Westmont, IL (US)

(73) Assignee: ELECTRO-MOTIVE DIESEL, INC., LaGrange, IL (US)

(21) Appl. No.: 14/689,617

(22) Filed: Apr. 17, 2015

(51) Int. Cl. G05D 1/02; B61L 25/02

(52) U.S. Cl. CPC G05D 1/0276; B61L 25/02; B61L 2205/00; B61L 2201/00

(57) ABSTRACT

A control system for autonomously controlling a locomotive may have at least one operational control device, on-board the locomotive, and configured to control an operational parameter of the locomotive. The control system may have an off-board remote controller interface, which may receive positional information associated with the locomotive and transmit route information to the locomotive. The control system may also include a locomotive controller located on-board the locomotive. The controller may transmit the positional information to the off-board remote controller interface and receive the route information from the off-board remote controller interface. The controller may also determine a target value of the operational parameter based on the positional information and the route information, and a transition between a current value of the operational parameter and the target value. In addition, the controller may send a command and control signal to the operational control device based on the transition.

### TECHNICAL FIELD

The present disclosure relates generally to a system and method for control of locomotives and, more particularly, to a system and method for autonomous control of locomotives.

### BACKGROUND

Rail vehicles often include multiple powered units, such as locomotives, mechanically coupled or linked together to form a consist. Rail vehicles can also include other non-powered units or rail cars mechanically coupled or linked to the consist. The non-powered units typically carry supplies for the operation of the consist, freight, and/or passengers. Links or couplers provide the mechanical coupling between the powered units in the consist, between the non-powered units, and between a consist and a non-powered unit. The consist operates to provide tractive and/or braking power to propel and/or stop movement of the rail vehicle. The level of traction or braking provided by the powered units may change over time depending on a location of the rail vehicle along its route. The level of traction or braking may be altered manually by a human operator or through a controller, which may adjust the operational parameters of the locomotives in the consist.

Changes to the tractive or braking power of the powered units generate compressive or tensile forces in the couplers. For example, applying braking power to the powered-units of the consist may cause the un-powered units of the rail vehicle to bunch up, generating compressive forces in the couplers. Likewise, applying tractive power to the powered units to cause acceleration may cause the couplers to stretch out, generating tensile forces in the couplers. To ensure safe operation of the rail vehicle, it is necessary to control the compressive and/or tensile forces in the couplers to prevent breakage or un-coupling of the couplers during operation of the rail vehicle.

A goal in the operation of rail vehicles is to eliminate the need for an on-board operator. To provide such an autonomous train operation, a reliable control system must be provided to transmit train control commands and other data indicative of operational characteristics associated with various subsystems of the consist between the rail vehicle and an off-board remote controller interface (also sometimes referred to as the “back office”). The control system must also be capable of transmitting data messages including information necessary to control the tractive and/or braking power of the powered units of the consist and information regarding operational characteristics of various consist subsystems during operation of the rail vehicle.

One example of a rail vehicle that includes a control system that allows the transfer of control commands from a lead locomotive to a remote locomotive is disclosed in U.S. Patent Application Publication No. 2014/0094998 of Klineman et al. that published on Apr. 3, 2014 (“the '998 publication”). In particular, the '998 publication discloses a control system that generates a trip plan that designates operational settings of a vehicle system having powered units that generate tractive effort to propel the vehicle system. The disclosed control system also determines a tractive effort capability of the vehicle system and a demanded tractive effort of a trip and identifies a difference between the tractive effort capability of the vehicle system and the demanded tractive effort of the trip. Based on the difference, the control system of the '998 publication selects at least one powered unit to be switched off. The disclosed control system turns the selected powered unit to an OFF mode such that the vehicle system is propelled along the route during the trip by the powered units other than the selected powered unit. The disclosed control system of the '998 publication can also turn a selected powered unit from an OFF mode to an ON mode.

Although the '998 publication discloses a control system to control operations of locomotives in a consist, the disclosed system may still not be optimal. In particular, when the disclosed system of the '998 publication turns a powered unit to an OFF mode or turns the powered unit from the OFF mode to the ON mode, excessive tensile and or compressive forces may still be induced in the couplers of the rail vehicle. Repeated exposure to such forces may cause breakage or uncoupling of the couplers of the rail vehicle.

The systems and methods of the present disclosure solve one or more of the problems set forth above and/or other problems in the art.

### SUMMARY

In one aspect, the present disclosure is directed to a control system for autonomously controlling a locomotive. The control system may include at least one operational control device located on-board the locomotive. The operational control device may be configured to control an operational parameter of the locomotive. The control system may also include an off-board remote controller interface located remotely from the locomotive. The off-board remote controller interface may be configured to receive positional information associated with the locomotive and transmit route information to the locomotive. The control system may further include a locomotive controller located on-board the locomotive. The locomotive controller may be configured to transmit the positional information to the off-board remote controller interface. The locomotive controller may also be configured to receive the route information from the off-board remote controller interface. Further, the locomotive controller may be configured to determine a target value of the operational parameter based on the positional information and the route information. The locomotive controller may also be configured to determine a transition between a current value of the operational parameter and the target value. In addition, the locomotive controller may be configured to selectively send a command and control signal to the operational control device based on the transition.

In another aspect, the present disclosure is directed to a method of autonomously controlling a locomotive. The method may include determining positional information associated with the locomotive. The method may also include transmitting the positional information to an off-board remote controller interface. Further, the method may include receiving route information from the off-board remote controller interface. The method may also include determining a target value of an operational parameter associated with the locomotive based on the positional information and the route information. The method may include determining a transition between a current value of the operational parameter and the target value. In addition, the method may include selectively sending a command and control signal to an operational control device associated with the locomotive based on the transition.

In yet another aspect, the present disclosure is directed to a rail vehicle. The rail vehicle may include a lead consist including a first locomotive and a trailing consist including a second locomotive. The rail vehicle may also include a positioning unit associated with the first locomotive. The positioning unit may be configured to determine a current position of the first locomotive. The rail vehicle may further include a first communication unit associated with the first locomotive and a second communication associated with the second locomotive. The rail vehicle may also include a first operational control device located on-board the first locomotive. The first operational control device may be configured to control a first operational parameter of the first locomotive. In addition, the rail vehicle may include a second operational control device located on-board the second locomotive. The second operational control device may be configured to control a second operational parameter of the second locomotive. The rail vehicle may include a locomotive controller located on-board the first locomotive. The locomotive controller may be configured to transmit the current position to the off-board remote controller interface using the first communication unit. The locomotive controller may also be configured to receive route information from the off-board remote controller interface using the first communication unit. Further, the locomotive controller may be configured to determine a first target value of the first operational parameter based on the current position and the route information. The locomotive controller may also be configured to determine a first transition between a first current value of the operational parameter and the first target value. Additionally, the locomotive controller may be configured to selectively send a first command and control signal to the first operational control device based on the first transition.

### BRIEF DESCRIPTION OF THE DRAWING

FIG. 1 is a schematic diagram of an exemplary disclosed embodiment of a control system for a train;

FIG. 2 is a block diagram of an exemplary disclosed implementation of a portion of the control system illustrated in FIG. 1; and

FIG. 3 is a flow chart depicting an exemplary disclosed method that may be performed by the control system of FIG. 2.

### DETAILED DESCRIPTION

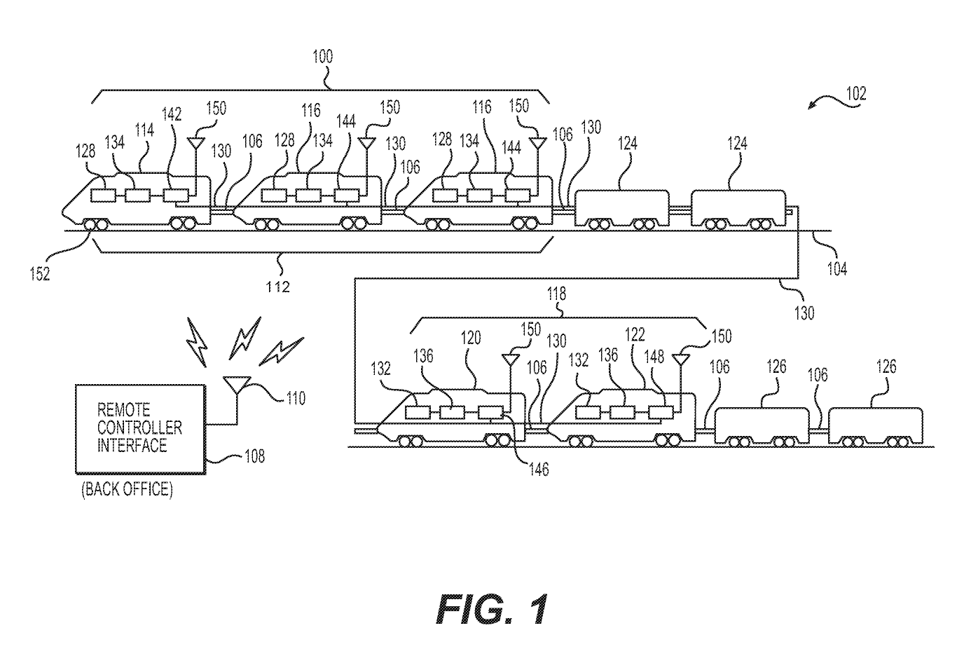

FIG. 1 is a schematic diagram of one embodiment of a control system 100 for operating train 102 traveling along track 104. Train 102 may include a single rail car or multiple rail cars (including powered and/or non-powered rail cars or units), linked together using couplers 106. Control system 100 may provide for autonomous operation and control of train 102. Control system 100 may also provide a means for remote operators or third party operators to communicate with the various locomotives or other powered units of train 102 from remote interfaces such as an off-board remote controller interface 108 to on-board controllers on train 102.

In various implementations, off-board remote controller interface 108 may comprise a laptop, hand-held device, other computing device, and/or server with software, encryption capabilities, and network access for communicating with train 102. Off-board remote controller interface 108 may be configured to transmit data, such as route information, which may include geographical maps, terrain maps, and/or various characteristics of all or a portion of the route that may be traveled on by train 102, to control system 100. For example, off-board remote controller interface 108 may transmit data, including grade information, regarding uphill or downhill portions of the route, to control system 100. Off-board remote controller interface 108 may also transmit other characteristics, for example, one or more radii of curvature for curved portions of track 104, an amount of banking of tracks 104, and/or speed limits on various portions of the route, to control system 100. In one exemplary embodiment, off-board remote controller interface 108 may transmit data, including, for example, grade information, radii of curvature, an amount of banking, and/or speed limits for a portion of the route extending from a current position of train 102 in a travel direction of train 102. In addition, off-board remote controller interface 108 may be configured to receive remote alerts and other data from a controller on-board train 102. Off-board remote controller interface 108 may forward those alerts and data to desired parties via pagers, mobile telephone, email, and online screen alerts. The data communicated between train 102 and off-board remote controller interface 108 may include signals indicative of various operational parameters associated with components and subsystems of the train, and command and control signals operative to change the state of, for example, various circuit breakers, throttles, brake controls, actuators, switches, handles, relays, and other electronically-controllable devices on-board any locomotive or other powered unit of train 102.

Off-board remote controller interface 108 may be connected with an antenna module 110 configured as a wireless transmitter or transceiver to wirelessly transmit data messages to train 102. The messages may originate elsewhere, such as in a rail-yard back office system, one or more remotely located servers (such as in the “cloud”), a third party server, a computer disposed in a rail yard tower, and the like, and be communicated to off-board remote controller interface 108 by wired and/or wireless connections. Alternatively, off-board remote controller interface 108 may be a satellite that transmits the message down to train 102 or a cellular tower disposed remote from train 102 and track 104. Other devices may be used as off-board remote controller interface 108 to wirelessly transmit the messages. For example, other wayside equipment, base stations, or back office servers may be used as off-board remote controller interface 108. By way of example only, off-board remote controller interface 108 may use one or more of the Transmission Control Protocol (TCP), Internet Protocol (IP), TCP/IP, User Datagram Protocol (UDP), or Internet Control Message Protocol (ICMP) to communicate network data over the network with train 102. As described below, the network data may include information regarding a current position of train 102, information used to automatically and/or remotely control operations of train 102 or subsystems of train 102, and/or reference information stored and used by train 102 during operation of train 102. The network data communicated to off-board remote controller interface 108 from train 102 may also provide alerts and other operational information that allows for remote monitoring, diagnostics, asset management, and tracking of the state of health of all of the primary power systems and auxiliary subsystems such as HVAC, air brakes, lights, event recorders, and the like.

Train 102 may include a lead consist 112 of powered locomotives, including interconnected powered units 114 and 116, one or more remote or trailing consists 118 of powered locomotives, including powered units 120, 122, and additional non-powered units 124, 126. As used in this disclosure, “powered units” refers to rail cars that are capable of self-propulsion, such as locomotives. Further, as used in this disclosure, “non-powered units” refers to rail cars that are incapable of self-propulsion, but which may otherwise receive electric power for other services. For example, freight cars, passenger cars, and other types of rail cars that do not propel themselves may be “non-powered units”, even though the cars may receive electric power for cooling, heating, communications, lighting, and other auxiliary functions.

In the illustrated embodiment of FIG. 1, powered units 114, 116 represent locomotives joined with each other in lead consist 112. Lead consist 112 represents a group of two or more locomotives in train 102 that are mechanically coupled or linked together via couplers 106 to travel along a route. Lead consist 112 may be a subset of train 102 such that lead consist 112 is included in train 102 along with additional trailing consists of locomotives, such as trailing consist 118, and additional non-powered units 124, 126, such as freight cars or passenger cars. While train 102 in FIG. 1 is shown with one lead consist 112, and one trailing consist 118, train 102 may include any number consists including one or more of powered units 114, 116, 120, 122 joined together or interconnected by one or more intermediate powered or non-powered units that do not form part of lead and trailing consists 112, 118.

Lead consist 112 includes a lead powered unit 114, such as a lead locomotive, and one or more trailing powered units 116, such as trailing locomotives. As used in this disclosure, the terms “lead” and “trailing” are designations of different powered units, and do not necessarily reflect positioning of the powered units 114, 116 in train 102 or in lead consist 112. For example, a lead powered unit may be disposed between two trailing powered units. Alternatively, the term “lead” may refer to the first powered unit in train 102, the first powered unit in lead consist 112, and the first powered unit in trailing consist 118. Further, as used in this disclosure, the term “trailing” powered units may refer to powered units positioned after a lead powered unit. In another exemplary embodiment, the term “lead” may refer to a powered unit that is designated for primary control of the lead consist 112 and/or the trailing consist 118, and “trailing” may refer to powered units that are under at least partial control of a lead powered unit.

Similar to lead consist 112, the embodiment shown in FIG. 1 also includes trailing consist 118, including a lead powered unit 120, such as a lead locomotive, and a trailing powered unit 122, such as a trailing locomotive. Trailing consist 118 may be located at a rear end of train 102, or at some intermediate point along train 102. Non-powered units 124 may separate lead consist 112 from trailing consist 118, and additional non-powered units 126 may be pulled behind the trailing consist 118.

Powered units 114, 116 may include a connection at each end to couple propulsion subsystems 128 of powered units 114, 116 such that powered units 114, 116 in lead consist 112 function together as a single tractive unit. Propulsion subsystems 128 may include electric and/or mechanical devices and components, such as diesel engines, electric generators, and traction motors, used to provide tractive effort that propels powered units 114, 116 and braking effort that slows powered units 114, 116.

Propulsion subsystems 128 of powered units 114, 116 in lead consist 112 may be connected and communicatively coupled with each other via network 130. In one exemplary embodiment, network 130 may include a net port and jumper cable that extends along the train 102 and between the powered units 114, 116. Network 130 may include a cable that includes twenty seven pins on each end that is referred to as a multiple unit cable, or MU cable. Alternatively, a different wire, cable, or bus, or other communication medium, may be used in network 130. For example, network 130 may include an Electrically Controlled Pneumatic Brake line (ECPB), a fiber optic cable, or wireless connection. Powered units 120, 122 of trailing consist 118 may also include propulsion subsystems 132 that may be connected and communicatively coupled to each other by network 130 including, for example, a MU cable extending between powered units 120, 122.

Network 130 may include several channels over which network data is communicated. Each channel may represent a different pathway for the network data to be communicated. For example, different channels may be associated with different wires or busses of a multi-wire or multi-bus cable. Alternatively, the different channels may represent different frequencies or ranges of frequencies over which the network data is transmitted.

Powered unit 114, 116 may include positioning units 134 configured to determine a geographical position of one or more of powered units 114, 116, 120, 122. For example, positioning units 134 may be configured to determine current positions of one or more of powered units 114, 116, 120, 122. Likewise, powered units 120, 122 may include positioning units 136 configured to determine a geographical position of one or more of powered units 114, 116, 120, 122. Positioning units 134, 136 may include one or more position sensors. A position sensor may embody, for example, a Global Positioning System (GPS) device, an Inertial Reference Unit (IRU), a local tracking system, or any other known position sensor capable of determining positional information associated with powered units 114, 116, 120, 122. In some exemplary embodiments, the positional information of powered units 114, 116, 120, 122 may be three-dimensional, although units providing only two-dimensional information may also be used.

Powered units 114, 116 may include communication units 142, 144, respectively, configured to communicate information used in controlling the operations of various components and subsystems, such as the propulsion subsystems 128 of powered units 114, 116. Communication units 142, 144 may also be configured to communicate positional information regarding one or more of powered units 114, 116, 120, 122 to off-board remote controller interface 108. The communication unit 142 disposed in lead powered unit 114 may be referred to as a lead communication unit. As described below, lead communication unit 142 may initiate the transmission of data packets forming a message to off-board remote controller interface 108. For example, lead communication unit 142 may transmit a message via a WiFi or cellular modem to off-board remote controller interface 108. The message may contain information on an operational state of lead powered unit 114, such as a throttle setting, a brake setting, readiness for dynamic braking, the tripping of a circuit breaker on-board the lead powered unit, or other operational characteristics. In one exemplary embodiment, the message may also contain information regarding a geographic position of powered unit 114. Communication units 142, 144 may also be configured to receive data packets forming a message from off-board remote controller interface 108. For example, communication units 142, 144 may receive route information for train 102 from off-board remote controller interface 108. Communication units 144 may be disposed in different trailing powered units 116 and may be referred to as trailing communication units. Alternatively, one or more of the communication units 142, 144 may be disposed outside of the corresponding powered units 114, 116 such as in nearby or adjacent non-powered units 124.

Another lead communication unit 146 may be disposed in lead powered unit 120 of trailing consist 118. Lead communication unit 146 of trailing consist 118 may be a unit that receives data packets forming a message transmitted by off-board remote controller interface 108 or from lead communication unit 142 of lead powered unit 114 of lead consist 112. In one exemplary embodiment, lead communication unit 146 of trailing consist 118 may receive a message from off-board remote controller interface 108 providing operational commands that are based upon the information transmitted to off-board remote controller interface 108 via lead communication unit 142 of lead powered unit 114 of lead consist 112. In another exemplary embodiment, lead communication unit 146 of trailing consist 118 may receive a message providing operational commands from lead communication unit 142 of leading consist 112. A trailing communication unit 148 may be disposed in trailing powered unit 122 of trailing consist 118, and interconnected with lead communication unit 146 via network 130. Alternatively, one or more of the communication units 146, 148 may be disposed outside of the corresponding powered units 120, 122 such as in nearby or adjacent non-powered units 126. Lead communication unit 146 and trailing communication units 148 may have structures and functions similar to those of lead communication unit 142 and trailing communication units 144, respectively.

Communication units 142, 144 in lead consist 112, and communication units 146, 148 in trailing consist 118 may be connected via network 130 such that all of the communication units for each consist are communicatively coupled with each other via network 130 and linked together in a computer network. Alternatively, communication units 142, 144, 146, 148 may be linked by another wire, cable, or bus, or by one or more wireless connections. The networked communication units 142, 144, 146, 148 may include antenna modules 150. Antenna modules 150 may represent separate individual antenna modules 150 or sets of antenna modules 150 disposed at different locations along train 102. For example, an antenna module 150 may represent a single wireless receiving device, such as a single 220 MHz TDMA antenna module, a single cellular modem, a single wireless local area network (WLAN) antenna module (such as a “Wi-Fi” antenna module capable of communicating using one or more of the IEEE 802.11 standards or another standard), a single WiMax (Worldwide Interoperability for Microwave Access) antenna module, a single satellite antenna module (or a device capable of wirelessly receiving a data message from an orbiting satellite), a single 3G antenna module, a single 4G antenna module, and the like. As another example, an antenna module 150 may represent a set or array of antenna modules, such as multiple antenna modules having one or more TDMA antenna modules, cellular modems, Wi-Fi antenna modules, WiMax antenna modules, satellite antenna modules, 3G antenna modules, and/or 4G antenna modules.

As shown in FIG. 1, antenna modules 150 may be disposed at spaced apart locations along a length of train 102. For example, single or sets of antenna modules 150 represented by each antenna module 150 may be separated from each other along the length of train 102 such that each single antenna module or antenna module set is disposed on a different powered or non-powered unit 114, 116, 120, 122, 124, 126 of train 102. Antenna modules 150 may be configured to send data to and receive data from off-board remote controller interface 108. For example, off-board remote controller interface 108 may include an antenna module 110 that wirelessly communicates the network data from a remote location that is off track 104 to train 102 via one or more of antenna modules 150. Alternatively, antenna modules 150 may be connectors or other components that engage a pathway over which network data is communicated, such as through an Ethernet connection.

The diverse antenna modules 150 may enable train 102 to receive network data transmitted by off-board remote controller interface 108 at multiple locations along train 102. Increasing the number of locations where network data can be received by train 102 may increase the probability that all, or a substantial portion, of a message conveyed by the network data is received by train 102. For example, if some antenna modules 150 are temporarily blocked or otherwise unable to receive network data as train 102 is moving relative to off-board remote controller interface 108, other antenna modules 150 that are not blocked and are able to receive the network data may receive the network data. An antenna module 150 receiving data and command control signals from off-board remote controller interface 108 may in turn re-transmit that received data and signals to the appropriate lead communication unit 142 of lead consist 112, or lead communication unit 146 of trailing consist 118. Any data packet of information received from off-board remote controller interface 108 may include header information or other means of identifying which locomotive in which locomotive consist the information is intended for. Although lead communication unit 142 on lead consist 112 may initiate transmission of data packets forming a message to off-board remote controller interface 108, all of the lead and trailing communication units may be configured to receive and transmit data packets forming messages to and from off-board remote controller interface 108. Accordingly, in various alternative implementations according to this disclosure, a command control signal providing operational commands for lead powered units 114, 120 and/or trailing powered units 116, 122 may originate at off-board remote controller interface 108, at lead powered unit 114 of lead consist 112, and/or at lead powered unit 120 of trailing consist 118.

Each locomotive or powered unit of train 102 may include a car body supported at opposing ends by a plurality of trucks. Each truck may be configured to engage track 104 via a plurality of wheels 152 and support a frame of the car body. One or more traction motors (not shown) may be associated with one or all wheels of a particular truck, and any number of engines (not shown) and generators (not shown) may be mounted to the frame within the car body to make up the propulsion subsystems 128, 132 on each of the powered units.

Propulsion subsystems 128, 132 of each of the powered units may be further interconnected throughout train 102 along one or more high voltage power cables in a power sharing arrangement. Energy storage devices (not shown) may also be included for short term or long term storage of energy generated by the propulsion subsystems or by the traction motors when the traction motors are operated in a dynamic braking or generating mode. Energy storage devices may include batteries, ultra-capacitors, flywheels, fluid accumulators, and other energy storage devices with capabilities to store large amounts of energy rapidly for short periods of time, or more slowly for longer periods of time, depending on the needs at any particular time. The DC or AC power provided from the propulsion subsystems 128, 132 or energy storage devices along the power cable may drive AC or DC traction motors to propel the wheels. Each of the traction motors may also be operated in a dynamic braking mode as a generator of electric power that may be provided back to the power cables and/or energy storage devices.

Control over engine operation (e.g., starting, stopping, fueling, exhaust aftertreatment, etc.) and traction motor operation, as well as other locomotive controls, may be provided by way of various controls housed within a cab supported by the frame of train 102. In some implementations of this disclosure, initiation of these controls may be implemented in the cab of lead powered unit 114 in lead consist 112 of train 102. In other alternative implementations, command and control signals operative to change the state of, for example, various circuit breakers, throttles, brake controls, actuators, switches, handles, relays, and other electronically-controllable devices may be provided by off-board remote controller interface 108 or by a controller on-board the one or more powered units 114, 116, 120, 122.

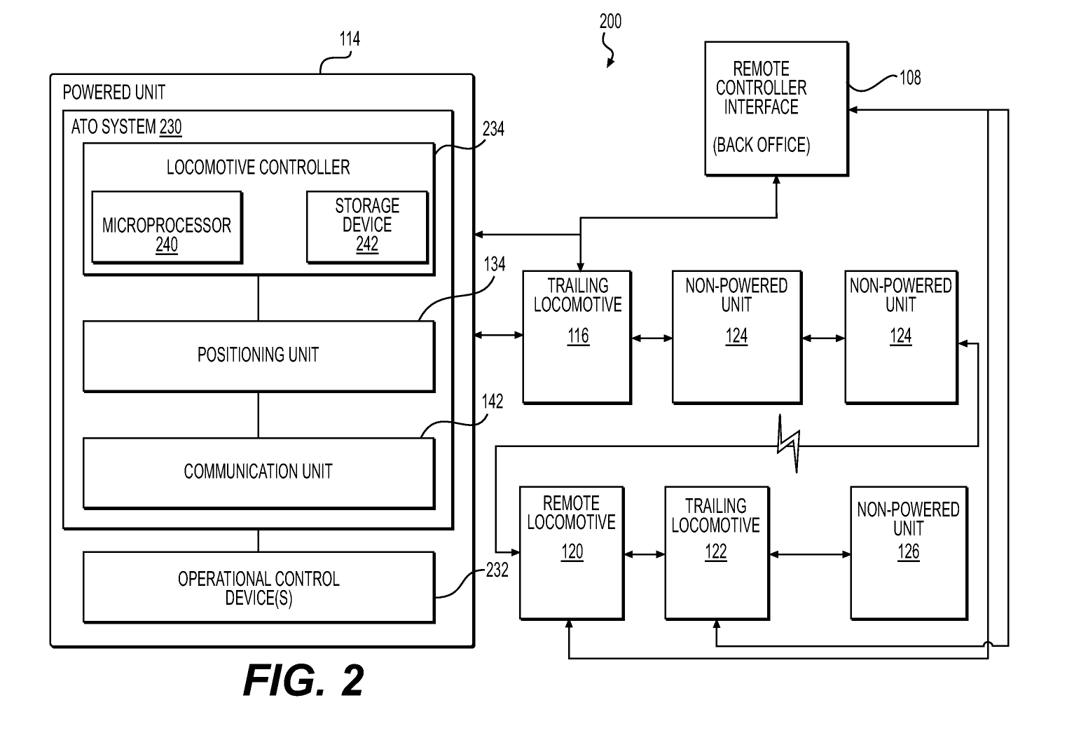

FIG. 2 illustrates an exemplary control system 200 for autonomous control of train 102. As shown in FIG. 2, lead powered unit 114 of lead consist 112 may include an autonomous train operation (ATO) system 230 and one or more operational control devices 232. ATO system 230 may include locomotive controller 234 and communication unit 142. Locomotive controller 234 may be communicatively coupled with the traction motors, engines, generators, braking subsystems, input devices, actuators, circuit breakers, and other devices and hardware used to control operation of various components and subsystems on the locomotive. Locomotive controller 234 may be configured to determine a variety of operational parameters, for example, one or more of throttle settings, brake settings, and/or other operational parameters for one or more of the powered units 114, 116, 120, 122 and/or non-powered units 124, 126 of train 102. Locomotive controller 234 may be configured to determine these operational parameters based on a variety of measured operational parameters, track conditions, freight loads, route information, and predetermined, tables, maps, or other stored data with one or more goals of improving availability, safety, timeliness, overall fuel economy and emissions output for individual powered units 114, 116, 120, 122, consists 112, 118, or for the entire train 102. The throttle settings, brake settings, and/or other operational parameters may be applied manually by an operator moving the appropriate controls, for example, actuators, switches, and/or handles, etc., in one or more of powered units 114, 116, 120, 122. Alternatively, locomotive controller 234 may output one or more corresponding command and control signals configured to at least one of change a throttle position, activate or deactivate dynamic braking, apply or release a pneumatic brake, respectively, and/or control the operation of operation of various components and subsystems associated with powered units 114, 116, 120, 122 and/or non-powered units 124, 126 of train 102.

In some exemplary embodiments, locomotive controller 234 may be configured to receive positional information from one or more positioning units 142 and to transmit the positional information to off-board remote controller interface 108. For example, locomotive controller 234 may be configured to receive and transmit current positions of powered units 114, 116, 120, 122 to off-board remote controller interface 108. Locomotive controller 234 may also be configured to receive route information, including, for example, terrain maps and/or route maps from off-board remote controller interface 108. In one exemplary embodiment, locomotive controller 234 may be configured to receive route information regarding a portion of the route, extending from a current position of lead powered unit 114 in a travel direction of lead powered unit 114. Locomotive controller 234 may additionally be configured to use the positional information and the route information to determine one or more operational parameters, including, for example, throttle settings, brake settings, etc. to achieve the one or more goals of improving availability, safety, timeliness, overall fuel economy and emissions output for individual powered units 114, 116, 120, 122, consists 112, 118, or for the entire train 102. In one exemplary embodiment, locomotive controller 234 may be configured to use the positional information and the route information to determine one or more consist-level operational parameters, including, for example, consist-level throttle settings, consist-level brake settings, etc. at a consist-level to achieve the one or more goals of improving availability, safety, timeliness, overall fuel economy and emissions output for one or more of consists 112, 118. Locomotive controller 234 may also be configured to determine optimum operational parameters, including, for example, throttle settings, brake settings, etc. for each of the powered units 114, 116, 120, 122 within the one or more consists 112, 118 to achieve the consist-level operational parameters determined by locomotive controller 234. In addition, locomotive controller 234 may be configured to communicate the determined operational parameters to other powered units 116, 120, 122 via communication network 130. In some exemplary embodiments, locomotive controller 234 may also be configured to output command and control signals configured to at least one of change a throttle position, activate or deactivate dynamic braking, and apply or release a pneumatic brake, respectively, associated with one or more of powered units 114, 116, 120, 122 to cause powered units 114, 116, 120, 122 to operate according to the determined operational parameters. It is contemplated, however, that locomotive controller 234 may be configured to output command and control signals configured to control other operational parameters associated with powered units 114, 116, 120, 122.

Powered units 114, 116, 120, 122 may be outfitted with any number and type of sensors known in the art for generating signals indicative of associated operational parameters. In one example, a locomotive may include a temperature sensor configured to generate a signal indicative of a coolant temperature of an engine on-board the locomotive. Additionally or alternatively, sensors may include brake temperature sensors, exhaust sensors, fuel level sensors, pressure sensors, knock sensors, reductant level or temperature sensors, speed sensors, motion detection sensors, location sensors, coupler force sensors, or any other sensor known in the art. The signals generated by the sensors may be directed to the locomotive controller 234 on each locomotive for further processing and generation of appropriate commands. Locomotive controller 234 may also include at least one integrated display configured to receive and display data from the outputs of one or more of machine gauges, indicators, sensors, and controls. Locomotive controller 234 may provide integrated computer processing and display capabilities on-board train 102, and may be communicatively coupled with the one or more sensors on-board the locomotive.

Any number and type of warning devices may also be located on-board each locomotive, including an audible warning device and/or a visual warning device. Warning devices may be used to alert an operator on-board a locomotive of an impending operation, for example startup of the engine(s). Warning devices may be triggered manually from on-board the locomotive (e.g., in response to movement of a component to the run state) and/or remotely from off-board the locomotive (e.g., in response to commands from the off-board remote controller interface 108.) When triggered from off-board the locomotive, a corresponding command signal used to initiate operation of the warning device may be communicated to locomotive controller 234. Although ATO system 230 has been described above in connection with powered unit 114, it is contemplated that powered units 116, 120, and 122 may also include ATO system 230.

Autonomous control of the various powered and non-powered units on the train 102 through off-board remote controller interface 108 and locomotive controller 234 may be facilitated via the various communication units 142, 144, 146, 148 spaced along the train 102. The communication units may include hardware and/or software that enables sending and receiving of data messages between the powered units of the train and the off-board remote controller interfaces. The data messages may be sent and received via a direct data link and/or a wireless communication link, as desired. The direct data link may include an Ethernet connection, a connected area network (CAN), or another data link known in the art. The wireless communications may include satellite, cellular, infrared, and any other type of wireless communications that enable the communication units to exchange information between the off-board remote controller interface 108 and the various components and subsystems of each of the locomotives or other powered units in the train 102.

Locomotive controller 234 may include at least one microprocessor 240 and at least one storage device 242. Microprocessor 240 may embody a single or multiple microprocessors, digital signal processors (DSPs), etc. Numerous commercially available microprocessors can be configured to perform the functions of microprocessor 240. Various other known circuits may be associated with locomotive controller 234, including power supply circuitry, signal-conditioning circuitry, actuator driver circuitry (i.e., circuitry powering solenoids, motors, or piezo actuators), and communication circuitry. Storage device 242 may be configured to store data or one or more instructions and/or software programs that perform functions or operations when executed by microprocessor 240. Storage device 242 may embody non-transitory computer-readable media, for example, Random Access Memory (RAM) devices, NOR or NAND flash memory devices, Read Only Memory (ROM) devices, CD-ROMs, hard disks, floppy drives, optical media, solid state storage media, etc. Although FIG. 2 illustrates locomotive controller 234 as having one microprocessor 240 and one storage device 242, it is contemplated that locomotive controller 234 may embody any number of microprocessors 240 and storage devices 242. Like locomotive controller 234, off-board remote controller interface 108 may also include one or more microprocessors 240 and one or more storage devices 242 similar to those described above with respect to locomotive controller 234.

An exemplary method of operating train 102 in accordance with various aspects of this disclosure is described in more detail in the following section.

### INDUSTRIAL APPLICABILITY

The control system of the present disclosure may be applicable to any group of locomotives or other powered machines where autonomous control of the machines may be desirable. An exemplary implementation of one mode of operation of control system 200 shown in the embodiment of FIG. 2 will now be described in detail.

During normal operation, a human operator may be located on-board lead locomotive 114 and within the cab of the locomotive. The human operator may be able to control when an engine or other subsystem of the train is started or shut down, which traction motors are used to propel the locomotive, what switches, handles, and/or other operational control devices 232 are reconfigured, and when and what circuit breakers are reset or tripped. The human operator may also be required to monitor multiple gauges, indicators, sensors, and alerts while making determinations on what controls should be initiated. However, there may be times when the operator is not available to perform these functions, when the operator is not on-board locomotive 114, and/or when the operator is not sufficiently trained or alert to perform these functions. In these situations, control system 200 in accordance with this disclosure may facilitate autonomous control of train 102 so as to reduce forces generated in couplers 106.

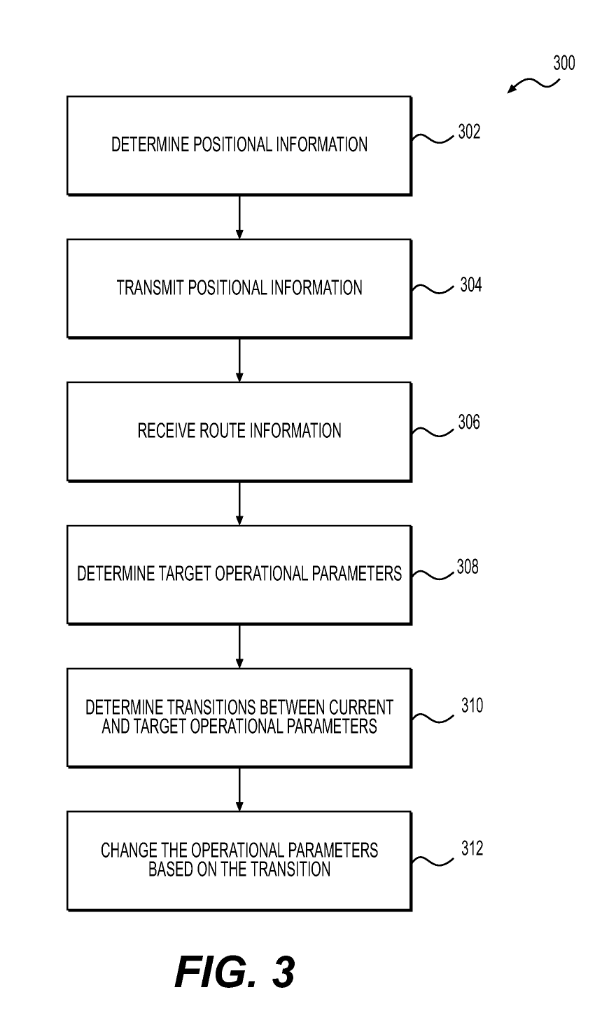

FIG. 3 illustrates an exemplary method 300 of autonomously controlling the operations of powered units or locomotives 114, 116, 120, 122. For example, method 300 may include a step of determining positional information by, for example, positioning unit 134 (Step 302). Determining positional information may include determining geographic co-ordinates of lead locomotive 114 using positioning unit 120 in lead locomotive 114 of lead consist 112. It is contemplated, however, that the co-ordinates of lead locomotive 114 may be determined by one or more of positioning units 134, 136 disposed in locomotives 116, 120, 122 and communicated to locomotive controller 234 of lead locomotive 114 by transmitting the positional information via network 130. For example, determining positional information may include determining current positions of one or more of locomotives 114, 116, 120, 122. Method 300 may further include a step of transmitting the positional information to off-board remote controller interface 108 (Step 304). The positional information may be transmitted from lead locomotive 114 via lead communication unit 142 to off-board remote controller interface 108. It is also contemplated that any of communication units 144, 146, 148 may transmit the positional information to off-board remote controller interface 108.

Method 300 may include a step of receiving route information (Step 306) from off-board remote controller interface 108, which may transmit the route information to communication unit 142 of lead locomotive 114. As discussed above, the route information may include information regarding terrain, grades, curvatures of track 104, speed limits, etc. on a portion of the route that train 102 must travel. For example, the route information may include data regarding terrain, grade, curvature, speed limits, etc. over a predetermined length of track 104 extending from a current position of lead locomotive 114 in a travel direction of lead locomotive 114.

Method 300 may include a step of determining target operational parameters (Step 308) for one or more of locomotives 114, 116, 120, 122. For example, locomotive controller 234 in lead locomotive 114 may determine the target operational parameters based on positional information of lead locomotive 114 and the route information by optimizing the operational parameters to achieve one or more goals of improving availability, safety, timeliness, overall fuel economy and emissions output for locomotives 114, 116, 120, 122, consists 112, 118, or for the entire train 102. In determining the target operational parameters, locomotive controller 234 may utilize physical models of various subsystems of locomotives 114, 116, 120, 122 and other information including, for example, a length of train 102, a number of consists 112, 118, a number of non-powered units 124, 126, freight load being carried by train 102, a maximum throttle and/or braking capacity of locomotives 114, 116, 120, 122, etc. It is contemplated that locomotive controller 234 may determine the operational parameters by executing a variety of mathematical algorithms and/or by looking up values of the operational parameters in look-up tables stored in storage devices 242 associated with locomotive controller 234 or with off-board remote controller interface 108. In some exemplary embodiments, locomotive controller 234 may use the positional information and the route information to determine one or more consist-level operational parameters, including, for example, consist-level throttle settings, consist-level brake settings, etc. to achieve the one or more goals of improving availability, safety, timeliness, overall fuel economy and emissions output for one or more of consists 112, 118. After determining consist-level operational parameters, locomotive controller 234 may also determine optimum operational parameters, including, for example, throttle settings, brake settings, etc. for each of the powered units 114, 116, 120, 122 within the one or more consists 112, 118 to achieve the consist-level operational parameters determined by locomotive controller 234. For example, locomotive controller 234 may determine a throttle setting “A” for lead consist 112. Locomotive controller 234 may further determine that lead locomotive 114 should operate at a throttle setting “B” and the one or more trailing locomotives should operate at a throttle setting “C,” where locomotive controller 234 may select throttle settings B and C so as to achieve a throttle setting A for lead consist 112. It is contemplated that step 308 may be performed by a locomotive controller 234 associated with any of locomotives 114, 116, 120, 122. It is also contemplated that in some exemplary embodiments, step 308 may be performed by off-board remote controller interface 108.

Method 300 may also include a step of determining transitions between current operational parameters and target operational parameters (Step 310) for locomotives 114, 116, 120, 122. Locomotive controller 234 may use physics-based models of train 102 together with route information, freight load carried by train 102, speed of train 102, etc. to determine the transitions to help reduce forces generated in couplers 106. In some exemplary embodiments, locomotive controller 234 may also use measurements of forces obtained by coupler force sensors (not shown) associated with couplers 106 to determine the transitions from current operational parameters to target operational parameters for locomotives 114, 116, 120, 122.

In one exemplary embodiment, determining the transitions may include determining a rate at which an operational parameter for locomotives 114, 116, 120, 122 may be changed from a current operational parameter to a target operational parameter. For example, determining the transitions may include determining a rate at which a throttle setting of lead locomotive 114 may be changed from a current throttle setting of lead locomotive 114 to a target throttle setting of lead locomotive 114. Locomotive controller 234 may determine the rate such that an increase in the force in one or more couplers 106 remains below a predetermined force threshold. The force threshold may be determined by testing couplers 106 or may be based on mathematical or physical models of couplers 106 and train 102.

The transition from a current operational parameter to a target operational parameter may be a continuous function or a stepwise function. When the transition is a continuous function, locomotive controller 234 may determine coefficients and/or constants required to define the continuous function. Determining the coefficients and/or constants may require execution of a variety of curve fitting and/or other mathematical algorithms, and determination of a rate of change of the operational parameter over time. In some exemplary embodiments, determining the coefficients and/or constants may include obtaining the values of the coefficients and/or constants from look-up tables stored in storage devices 242 associated with locomotive controller 234 and/or off-board remote controller interface 108.

When locomotive controller 234 determines the transition between the current operational parameter and the target operational parameter to be a stepwise function, locomotive controller 234 may determine a number “n” of intermediate stages between the current operational parameter and the target operational parameter. Locomotive controller 234 may also determine an intermediate operational parameter value for each of the n number of stages, and a duration of time for which the intermediate operational parameter may be maintained at each intermediate stage. Locomotive controller 234 may determine each of the intermediate operational parameter values and the corresponding duration of time so that an increase in forces generated in one or more couplers 106 remains below the predetermined force threshold. Locomotive controller 234 may store the determined intermediate operational parameter values and the duration of time corresponding to each intermediate operational parameter value in storage devices 242 associated with locomotive controller 234 and/or with off-board remote controller interface 108.

Method 300 may include a step of changing the operational parameters for locomotives 114, 116, 120, 122 (Step 312) based on the transition. As discussed above, the operational parameters may be applied to locomotives 114, 116, 120, 122 by sending command and control signals to hardware such as electronically controlled actuators or electrohydraulic actuators associated with the operational control devices 232, circuit breakers, and other components of locomotives 114, 116, 120, 122. When the transition is a continuous function, locomotive controller 234 may send command and control signals based on the coefficients and/or constants associated with the continuous function to continuously change one or more operational parameters of one or more locomotives 114, 116, 120, 122 from current values of the operational parameters to the target values of the operational parameters. When the transition is a stepwise function, locomotive controller may send command and control signals to apply each of the intermediate values of the operational parameters for the corresponding duration of time associated with the intermediate value. For example, locomotive controller 234 may send command and control signals to change an operational parameter for lead locomotive 114 from a current value of the operational parameter to a first intermediate value of the operational parameter. Locomotive controller 234 may simultaneously initialize and initiate a timer to determine a first duration of elapsed time. When the elapsed time exceeds a first amount of time associated with the first intermediate value of the operational parameter, locomotive controller 234 may send command and control signals to change the operational parameter from the first intermediate value of the operational parameter to a second intermediate value of the operational parameter. Locomotive controller 234 may also simultaneously initialize and initiate the timer to determine a second duration of elapsed time. Locomotive controller 234 may repeat these steps until an operational parameter of lead locomotive 114 has been changed from the current value of the operational parameter to the target value of the operational parameter.

It will be apparent to those skilled in the art that various modifications and variations can be made to the control system and method of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalents.

1. A control system for autonomously controlling a locomotive, the control system comprising:
at least one operational control device located on-board the locomotive, the operational control device being configured to control an operational parameter of the locomotive;
an off-board remote controller interface located remotely from the locomotive and being configured to
receive positional information associated with the locomotive, and
transmit route information to the locomotive; and
a locomotive controller located on-board the locomotive and being configured to
transmit the positional information to the off-board remote controller interface,
receive the route information from the off-board remote controller interface,
determine a target value of the operational parameter based on the positional information and the route information,
determine a transition between a current value of the operational parameter and the target value,
wherein determining the transition includes
determining a number of intermediate stages for the operational parameter between the current value and the target value,
determining an intermediate value of the operational parameter at each stage of the intermediate stages, and
determining a duration of time corresponding to the intermediate value,
selectively send a command and control signal to the operational control device based on the transition, and
maintain a control set point for the operational parameter at the intermediate value for the duration of time.

2. The control system of claim 1, further comprising a positioning unit configured to determine a current position of the locomotive,
the locomotive controller being further configured to transmit the current position to the off-board remote controller interface via wireless communication.

3. The control system of claim 2, wherein the off-board remote controller interface is further configured to transmit the route information for a portion of a route extending from the current position of the locomotive in a travel direction of the locomotive.

4. The control system of claim 1, wherein the locomotive controller is further configured to determine the transition such that an increase in force generated in a coupler associated with the locomotive is less than a predetermined force threshold.

5. The control system of claim 4, wherein the transition is defined by a continuous function.

6. The control system of claim 4, wherein the transition is defined by a stepwise function.

7. (canceled)

8. The control system of claim 1, wherein the locomotive controller is further configured to
send a first command and control signal corresponding to a first intermediate value of the operational parameter to the operational control device,
determine a duration of elapsed time, and
send a second command and control signal corresponding to a second intermediate value of the operational parameter to the operational control device, when the duration of elapsed time exceeds the duration of time corresponding to the first intermediate value.

9. The control system of claim 1, wherein the locomotive is a first locomotive, the operational parameter is a first operational parameter, the current value is a first current value, the target value is a first target value, and the locomotive controller is further configured to:
determine a second target value of a second operational parameter associated with a second locomotive, based on the positional information and the route information;
determine a second transition between a second current value of the second operational parameter and the second target value; and
selectively send a second command and control signal to a second operational control device associated with the second locomotive based on the second transition.

10. A method for autonomously controlling a locomotive, the method being executed by a locomotive controller and comprising:
determining positional information associated with the locomotive;
transmitting the positional information to an off-board remote controller interface;
receiving route information from the off-board remote controller interface;
determining a target value of an operational parameter associated with the locomotive based on the positional information and the route information;
determining a transition between a current value of the operational parameter and the target value, wherein determining the transition includes
determining a number of intermediate stages for the operational parameter between the current value and the target value,
determining a first intermediate value of the operational parameter at a first intermediate stage, and
determining a first duration of time corresponding to the first intermediate value;
selectively sending a command and control signal to an operational control device associated with the locomotive based on the transition; and
maintaining a control set point for the operational parameter at the first intermediate value for the first duration of time.

11. The method of claim 10, further comprising:
determining a current position of the locomotive using a positioning unit associated with the locomotive; and
transmitting the current position of the locomotive to the off-board remote controller interface via wireless communication.

12. The method of claim 10, wherein receiving the route information includes receiving the route information for a portion of a route extending in a travel direction of the locomotive from a current position of the locomotive.

13. The method of claim 12, wherein the route information comprises grade information, one or more radii of curvature, information regarding banking of the portion of the route, and speed limits on the portion of the route.

14. The method of claim 10, wherein determining the transition is based on reducing a force generated in a coupler associated with the locomotive.

15. The method of claim 10, wherein the transition is a continuous function and the method further includes determining at least one coefficient and at least one constant associated with the continuous function.

16. The method of claim 10, wherein the transition is a stepwise function and the method further includes:
determining a second intermediate value of the operational parameter at a second intermediate stage;
determining a second duration of time associated with the first intermediate value; and
maintaining the control set point for the operational parameter at the second intermediate value for the second duration of time, the second duration of time following the first duration of time.

17. The method of claim 16, further including:
sending a first command and control signal corresponding to the first intermediate value of the operational parameter to the operational control device;
initializing a timer to determine a duration of elapsed time; and
sending a second command and control signal corresponding to the second intermediate value of the operational parameter to the operational control device, when the duration of elapsed time exceeds the first duration of time.

18. The method of claim 10, wherein the locomotive is a first locomotive, the operational parameter is a first operational parameter, the current value is a first current value, the target value is a first target value, and the method further comprises:
determining a second target value of a second operational parameter associated with a second locomotive, based on the positional information and the route information;
determining a second transition between a second current value of the second operational parameter and the second target value; and
selectively sending a second command and control signal to a second operational control device associated with the second locomotive based on the second transition.

19. A railway vehicle, comprising:
a lead consist including a first locomotive;
a trailing consist including a second locomotive;
a positioning unit associated with the first locomotive, the positioning unit being configured to determine a current position of the first locomotive;
a first communication unit associated with the first locomotive;
a second communication unit associated with the second locomotive;
a first operational control device located on-board the first locomotive, the first operational control device being configured to control a first operational parameter of the first locomotive;
a second operational control device located on-board the second locomotive, the second operational control device being configured to control a second operational parameter of the second locomotive; and
a locomotive controller located on-board the first locomotive and being configured to:
transmit the current position to an off-board remote controller interface using the first communication unit;
receive route information from the off-board remote controller interface using the first communication unit;
determine a first target value of the first operational parameter based on the current position and the route information;
determine a first transition between a first current value of the operational parameter and the first target value, wherein determining the first transition includes
determining a number of intermediate stages for the first operational parameter between the first current value and the first target value,
determining an intermediate value of the operational parameter at each stage of the intermediate stages, and
determining a duration of time corresponding to the intermediate value;
selectively send a first command and control signal to the first operational control device based on the first transition; and
maintain a control set point for the first operational parameter at the intermediate value for the duration of time.

20. The railway vehicle of claim 19, wherein the locomotive controller is further configured to:
determine a second target value of the second operational parameter based on the current position and the route information;
determine a second transition between a second current value of the second operational parameter and the second target value; and
selectively communicate with the second communication unit to send a second command and control signal to the second operational control device based on the second transition.
